(19) United States
(12) Patent Application Publication
(10) Pub. No.: US 2007/0287511 A1
(43) Pub. Date: Dec. 13, 2007

(54) Device architecture using separate applications and communications modules

(76) Inventors: Tero Koivunen, El Dorado Hills, CA (US); Martin K. Schroeder, El Dorado Hills, CA (US)

Correspondence Address: INTEL CORPORATION;c/o INTELLEVATE, LLC, P.O. BOX 52050, MINNEAPOLIS, MN, 55402, US

(21) Appl. No.: 11/449,255

(22) Filed: Jun. 7, 2006

(51) Int. Cl. H04M 1/00

(52) U.S. Cl. 455/574

(57) ABSTRACT

A wireless communications device comprising an applications module and a communications module. The communications module and the applications module may be physically connected or they may be wirelessly connected through a short-range wireless technology such as Bluetooth, Ultra-Wideband (UWB), Certified Wireless USB, Infrared, or similar technology. In some instances the communications module and the applications module may be connected both physically and wirelessly. The wireless communications device may communicate as a combined system using long-range wireless technology such as Global System for Mobile Communications (GSM), Enhanced Data Rates for Global Evolution (EDGE), Universal Mobile Telecommunications System (UMTS), Code Division Multiple Access (CDMA) or similar technology.

### FIELD OF THE INVENTION

The field of invention relates generally to a wireless communications device comprising an applications module and a communications module and more specifically but not exclusively relates to a wireless communications device that can transmit and receive voice or data using long-range communications technology while allowing one or more applications modules to communicate with a variety of communications modules using short-range wireless communications technology.

### BACKGROUND INFORMATION

Handheld wireless communication devices are commonly used by consumers to communicate either verbally, by text messaging, or by receiving or sending data to or from the wireless device. A contemporary handheld wireless communication device combines telecommunications and computer capabilities to access various types of media either in recorded form or in real-time.

Handheld wireless communication devices contain elements necessary to support communications and applications capabilities. The communications elements, such as radio frequency transceivers, analog, processor, flash and random access memory devices provide the ability to turn speech into electrical signals that can be processed and transmitted, and vice versa. The applications elements, such as power management, display, processor, and peripheral devices provide an interface for the user to control the operation of the handheld wireless communication device and to provide functionality the user desires. Software necessary to support the functionality, including the operating system, drivers, applications, and media reside in the memory devices. Typically, all these elements are combined into one package that is designed and assembled by a single manufacturer and sold to the end user by a single wireless carrier. As a result, the combination of applications and communications capabilities available to the end user is limited to those offered by the original equipment manufacturer and distributed by the wireless carrier.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1A is an illustration of an applications module and at least one communications module in communication with a service provider.

FIG. 1B is an illustration of a communications module and at least one applications module in communication with a service provider.

FIG. 2 is an illustration of elements that may be found in a communications module and an applications module.

FIG. 3 is a diagram illustrating examples of various operating states of a communications module.

FIG. 4 is a flowchart describing an example of how a communications module processes an incoming call.

FIG. 5 is a flowchart describing an example of how an applications module processes a call initiated by the applications module.

### DETAILED DESCRIPTION

Embodiments of methods and apparatus for a device architecture using separate applications and communications modules are described herein. In the following description, numerous specific details are set forth such as a description of a communications module and an applications module to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

It would be an advance in the art to create a new handheld wireless communications device architecture, driving a disruptive product category whereby the communications and applications elements of the device are separated into two modules. Separate modules would enable applications to evolve separately from communications standards and would allow various applications modules to interact with one or more communications modules, and vice versa. An open platform framework with separate communications and applications modules would enable next generation internet applications for handheld devices to develop independent of newly emerging communications standards. Eliminating the need to bundle communications elements with the applications elements would also lower the barrier to entry for potential applications module manufacturers, resulting in a greater variety of options in the marketplace. As a result, an end-user would be able to customize the communications and applications elements based on the end-user's unique needs.

In one embodiment, an end-user may choose to own a collection of communication modules and locate the collection of communication modules in targeted locations such as a home, an office, and an automobile. The end-user would also own at least one applications module that may be used with the collection of communications modules.

In another embodiment, the end-user may own a collection of applications modules that may be used with at least one communications module. This would allow the end-user to purchase and use specific applications modules based on criteria important to the end-user such as functionality, size, price, capability, and scalability.

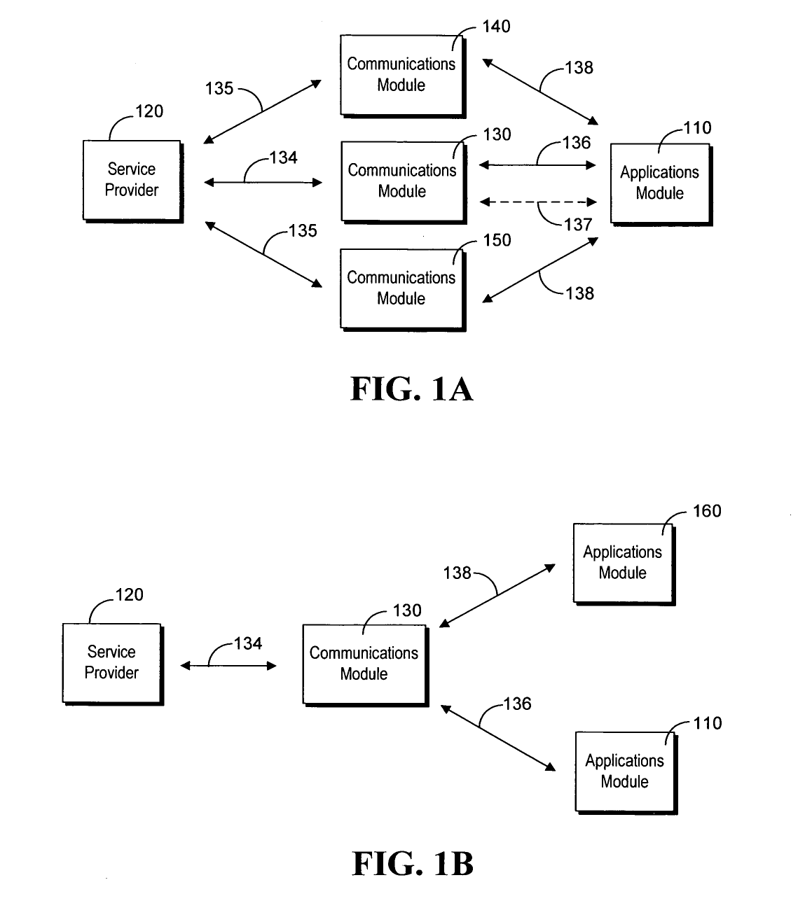

Turning now to the figures, FIG. 1A illustrates an exemplary embodiment of a communications device that includes a mobile applications module 110 (hereinafter applications module) in communication with a service provider 120 through a communications module 130. Applications module 110 may share characteristics common with various types of mobile wireless devices, such as cellular phones, personal digital assistants (PDAs), pocket personal computers (PCs), handheld computer devices, etc. As an example, an applications module 110 may support one or more functions such as baseband voice communications and data communications including internet, email, streaming music, mobile television, and global positioning. Further, the applications module 110 may be used to support an operating system or an application such as spreadsheet, word processing, or video game software. In one embodiment, the applications module 110 monitors and controls the functions of the communications module 130 through an operating command signal using a low power short-range wireless technology 136. In another embodiment, the applications module 110 may be physically connected to the communications module 130 using a wired connection 137.

The short-range wireless technology 136, such as Bluetooth wireless technology, may communicate both voice and data signals over a distance of up to 10 meters in a frequency range between 2.402 gigahertz (GHz) and 2.480 GHz. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported. Alternatively the short-range wireless technology 136, such as ultra-wideband (UWB), may communicate digital data over a wide spectrum of frequency bands ranging in a frequency range between 3.1 GHz and 10.6 GHz. Other examples of a short-range wireless technology 136 includes certified wireless universal serial bus (USB), and communications defined by the Institute of Electrical Institute of Electrical and Electronic Engineers (IEEE) 802.11, Wireless Fidelity (Wi-Fi) and IEEE 802.16 Worldwide Interoperability for Microwave Access (WiMAX) suites of standards. IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents.

The communications module 130 may be a wireless communications device that may be used to transmit and receive signals between the applications module 110 and the service provider 120. In one embodiment, the communications module may communicate with the service provider 120 by a communications signal 134 using a long-range wireless protocol such as a wide area network (WAN), a general packet radio system (GPRS), enhanced data rates for global evolution (EDGE), or third-generation wireless (3G). The communications module 130 may also communicate with applications module 110 using the short-range technology 136. In another embodiment, the communications module 130 may provide an interface for voice communications independent of the applications module 110.

The applications module 110 may communicate with a plurality of communications modules. For example, the applications module 110 may also communicate with a communications module 140 located in a car and a communications module 150 located in a home. In one embodiment, the communications module 140 may communicate with the service provider 120 by a communications signal 135 using a second long-range wireless protocol such as a wide area network (WAN), a general packet radio system (GPRS), enhanced data rates for global evolution (EDGE), or third-generation wireless (3G).

The communications module 130 may broadcast its presence using an intermittent signal, or beacon, and wait to be detected by the applications module 110. The applications module 110 may detect one or more available communications modules 130 in its operating range and may select an appropriate communications module 130 using a selection process based on an operating state and a device parameter. A device parameter is a metric used to determine a preferred communications channel. The selection process may be governed by predetermined rules set by a user, an operator, or a device manufacturer which include, but are not limited to signal strength, distance, class of device, preference class of device, security settings, a service identification, or a unique device identification or address.

FIG. 1B illustrates another embodiment of a communications device that includes an applications module 110 in communication with a service provider 120 through a communications module 130. The communications module may communicate with the service provider 120 by a communications signal 134 using a long-range wireless protocol such as a wide area network (WAN), a general packet radio system (GPRS), enhanced data rates for global evolution (EDGE), or third-generation wireless (3G). The applications module 110 may monitor and control the functions of the communications module 130 through an operating command signal using the low power short-range wireless technology 136. An applications module 160 may also monitor and control the functions of the communications module 130 through an operating command signal using a second low power short-range wireless technology 138.

The short-range wireless technology 138, such as Bluetooth wireless technology, may communicate both voice and data signals over a distance of up to 10 meters in a frequency range between 2.402 gigahertz (GHz) and 2.480 GHz. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported. Alternatively the short-range wireless technology 138, such as ultra-wideband (UWB), may communicate digital data over a wide spectrum of frequency bands ranging in a frequency range between 3.1 GHz and 10.6 GHz. Other examples of a short-range wireless technology 133 includes certified wireless universal serial bus (USB), and communications defined by the Institute of Electrical Institute of Electrical and Electronic Engineers (IEEE) 802.11, Wireless Fidelity (Wi-Fi) and IEEE 802.16 Worldwide Interoperability for Microwave Access (WiMAX) suites of standards. IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents.

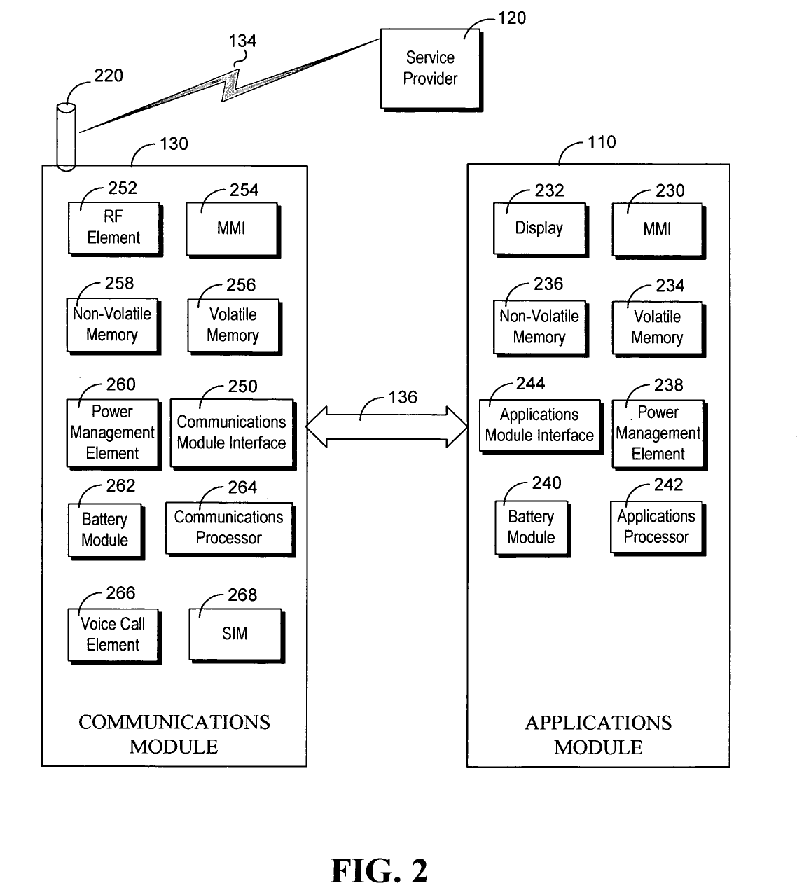

FIG. 2 illustrates the elements that may be found in an applications module 110 and a communications module 130. An element may be hardware, software, firmware, or any combination thereof. The applications module may contain a man-machine interface (MMI) 230 to allow a user to interact with the applications module 110. The MMI 230 may comprise at least one of a keyboard, a touch screen, a series of buttons, a speaker, or a microphone. A display 232 may allow the user view the state of a communications module 130 or to view the output of applications software that is executed on the applications module 110. The applications module 110 may include a volatile memory 234, such as dynamic random access memory (DRAM) or static random access memory (SRAM), to store software and data while the applications module is powered. In some embodiments, the volatile memory 234 may be used as a temporary storage until it is appropriate to transfer the data from the volatile memory 234 to a non-volatile memory 236. The applications module 110 may also include a non-volatile memory 236 to persistently store software and data even when the applications module 110 is not powered. Examples of a non-volatile memory 236 may include read-only memory, flash memory, magnetic computer storage devices, or optical drives.

To reduce the power consumption of the applications module 110, a power management element 238 may be used to extend the operating life of a battery module 240. When the applications module 110 is not actively being used, the power management element 238 may inactivate an applications processor 242 so that the applications processor 242 consumes little or no power. In one embodiment, the applications processor 242 may be a microprocessor, a microcontroller, or a digital signal processor (DSP). The applications module 110 may transmit and/or receive a short-range wireless technology 136 using an applications module interface 244. In one embodiment, the applications module interface 244 may comprise a radio to modulate and demodulate signals that are transmitted and received by the applications module 110, a Bluetooth core, a microprocessor, a host controller interface transport, and a pulse code modulation element.

Similarly, a communications module 130 may contain a man-machine interface (MMI) 254 to allow a user to interact with the communications module 130. The MMI 254 may comprise at least one of a keyboard, a touch screen, a series of buttons, a speaker, or a microphone. The communications module 130 may include a volatile memory 256, such as dynamic random access memory (DRAM) or static random access memory (SRAM), to store software and data while the applications module is powered. The communications module 130 may also include a non-volatile memory 258 to persistently store software and data even when the applications module 110 is not powered. Examples of a non-volatile memory 258 may include read-only memory, flash memory, magnetic computer storage devices, or optical drives.

A power management element 260 may be used to extend the operating life of a battery module 262. The power management element 260 may inactivate a communications processor 264 so that the communications processor 264 consumes little or no power when the communications module 130 is not being used. In one embodiment, the communications processor 264 may be a microprocessor, a microcontroller, or a digital signal processor. The communications module 130 may transmit and receive the short-range wireless technology 136 using a communications module interface 250. In one embodiment, the communications module interface 250 may comprise a radio to modulate and demodulate signals that are transmitted and received by the communications module 130, a Bluetooth core, a microprocessor, a host controller interface transport, and a pulse code modulation element. In addition, the communications module 130 may include a voice call element 266 to allow a user to initiate or receive a phone call without using the applications module 110. The communications module 130 may also include a subscriber identity module (SIM) 268 to securely store a key that identifies a user's mobile phone service subscription information.

In one embodiment, the communications module 130 may receive and transmit a communications signal 134 to a service provider 120 using a radio frequency (RF) element 252 and an antennae 220. The RF element 252 may comprise an analog to digital converter, a digital to analog converter, a DSP, and other components such as filters, decoders, and multipliers that may be used to process baseband or intermediate frequency (IF) signals.

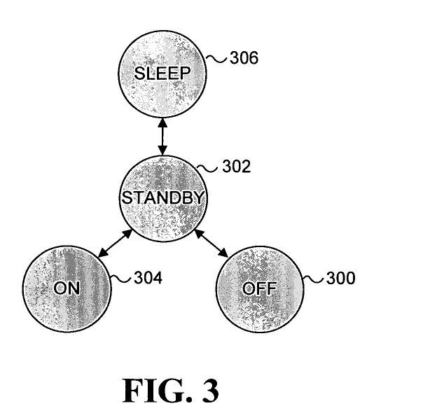

FIG. 3 is a diagram that illustrates various operating states of a communications module 130. In one embodiment, the communications module 130 may begin in an OFF operating state 300. An operating state indicates a level of activity supported by the communications module 130. For example, an OFF operating state 300 indicates that the communications module 130 is powered off and no incoming or outgoing calls are supported by the communications module 130. An operating command signal may be sent by an applications module 110 to instruct the communications module 130 to enter a STANDBY state 302. Alternatively, the communications module 130 may enter a STANDBY state in response to an input received via the MMI 254.

The operating command signal is a signal sent by the applications module 110 to one or more communications modules 130 to specify an operating state of a communications module 130. Once in a STANDBY state 302, the communications module 130 may send frequent intermittent signals indicating an operating state and one or more device parameters of the communications module 130. The applications module 110 may initiate a communication using the communications module 130, thereby changing the operating state of the communications module 130 from a STANDBY state 302 to an ON state 304. Also while in the STANDBY state 302, the communications module 130 may receive an incoming call event and transmit an incoming call signal to an applications module 110. The applications module 110 may send an operating command signal to accept the incoming call, thereby changing the operating state of the communications module 130 from a STANDBY state 302 to an ON state 304. The operating state of the communications module 130 may then be changed from an ON state 304 to a STANDBY state 302 after completing the call.

The communications module may also enter a SLEEP state 306 due to prolonged inactivity. The communications module 130 may enter the SLEEP state 306 based on pre-programmed criteria or it may enter the SLEEP state 306 after receiving an operating command signal from an applications module 110.

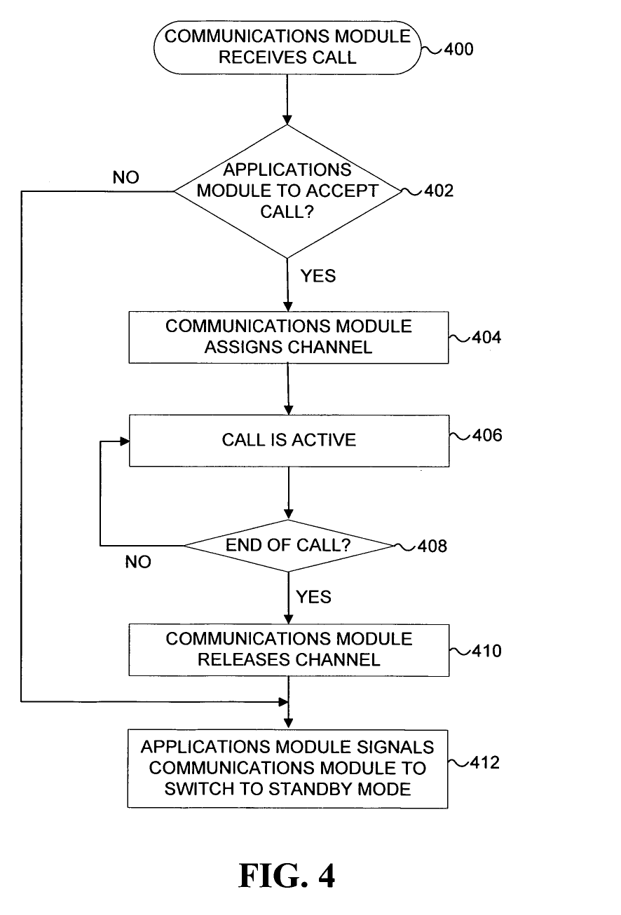

FIG. 4 is a flowchart describing an embodiment of how a communications module 130 may process an incoming call. A communications module 130 may receive an incoming call 400 and may transmit an incoming call signal to an applications module 110. The applications module 110 is given the opportunity to either accept the incoming call, or deny the call 402. If the applications module 110 denies the call, the applications module 110 may send an operating command signal to the communications module 130 to switch to standby mode 412. If the application module 110 accepts the incoming call, then the communications module 130 may assign a communication channel 404. An active call may be initiated 406 after establishing a communication channel. The communications channel may remain open 408 until the call is terminated. The communications module 130 may release the communication channel 410 after the applications module 110 terminates the call. The applications module 110 may then send an operating command signal to the communications module 130 to switch to standby mode 412.

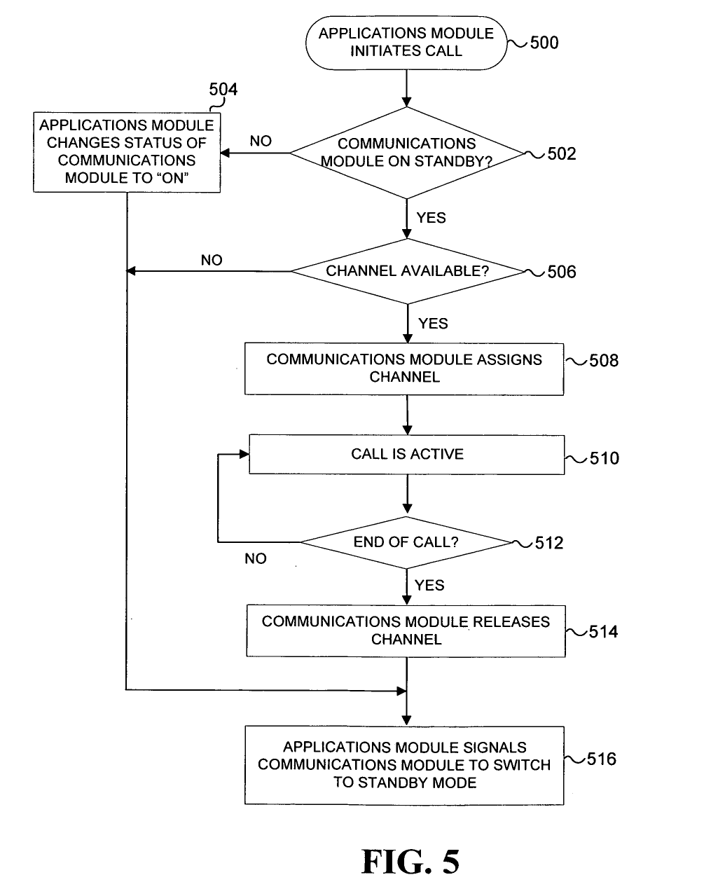

FIG. 5 is a flowchart describing an example of how an applications module 110 may process a call initiated by the applications module 110. In this embodiment, the applications module 110 may initiate an outgoing call 500 to a communications module 130. The applications module 110 may then determine whether an available communications module 130 is on standby 502. If the applications module 110 fails to locate a communications module 130 in standby mode, the applications module 110 may send an operating command signal to change the status of an available communications module to an ON operating state 504. The applications module 110 may then send an operating command signal to the communications module 130 to switch to a standby operating state 516.

However, if the applications module 110 does locate a communications module 130 in standby mode, the communications module 130 may attempt to locate an available communications channel 506. If a communications channel is not available, then the applications module 110 may send an operating command signal to the communications module 130 to switch to a standby operating state 516. If a communications channel is available, the communications module 130 may assign a communications channel 508. An active call may be initiated 510 after establishing a communication channel. The communications channel may remain open 512 until the call is terminated. The communications module 130 may release the communication channel 514 after the applications module 110 terminates the call. The applications module 110 may then send an operating command signal to the communications module 130 to switch to standby mode 516.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. In the description and claims, the terms “coupled” and “connected,” along with their derivatives, may have been used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Thus, embodiments of this invention may be used as or to support a software program executed upon some form of processing core (such as a processor of a computer) or otherwise implemented or realized upon or within a machine-readable medium. A machine-readable medium includes any mechanism for storing information in a form readable by a machine (e.g., a computer). For example, a machine-readable medium can include such as a read only memory (ROM); a random access memory (RAM); a magnetic disk storage media; an optical storage media; and a flash memory device, etc.

Modifications may be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A communications module comprising:
a radio frequency element to transmit and receive a communications signal using a long-range wireless protocol;
a communications processor coupled to the radio frequency element;
a power management element to periodically inactivate said communications processor to reduce power consumption of the communications module;
a voice call element connected to the communications processor for voice communications; and
a communications module interface to transmit and receive the communications signal wherein the communications module interface transmits an operating state signal and receives an operating command signal.

2. The communications module of claim 1, wherein the communications module interface transmits using a short-range wireless technology in a frequency range between 2.402 GHz and 2.480 GHz.

3. The communications module of claim 1, wherein the communications module interface transmits using a short-range wireless technology in a frequency range between 3.1 GHz and 10.6 GHz.

4. The communications module of claim 1, wherein the communications module interface is physically connected to an applications module.

5. An applications module comprising:
a display;
an applications processor;
a power management element to periodically inactivate said applications processor to reduce power consumption of the applications module;
a voice call element connected to the applications processor for voice communications; and
an applications module interface to transmit and receive a communication signal wherein the applications module receives an operating state signal and transmits an operating command signal.

6. The applications module of claim 5, wherein the applications module interface transmits using a short-range wireless technology in a frequency range between 2.402 GHz and 2.480 GHz.

7. The applications module of claim 5, wherein the applications module interface transmits using a short-range wireless technology in a frequency range between 3.1 GHz and 10.6 GHz.

8. The applications module of claim 5, wherein the applications module is physically connected to a communications module.

9. A method of relaying signals with a communications module, comprising:
receiving and transmitting a communications signal at a first frequency by a radio frequency element and processing said communications signal by a communications module;
providing an interface for voice communications using the communications module;
transmitting an intermittent signal by a communications module interface at a second frequency indicating an operating state and a device parameter of the communications module;
activating a power management element to periodically reduce power consumption of the communications module; and
transmitting an incoming call signal by the communications module interface at the second frequency indicating an incoming call event.

10. The method of claim 9, wherein the first frequency is a long-range wireless protocol comprising at least one of a wide area network (WAN), a general packet radio system (GPRS), enhanced data rates for global evolution (EDGE), or third-generation wireless (3G).

11. The method of claim 9, wherein the device parameter comprises at least one of a signal strength, distance, class of device, preference class of device, security settings, service identification, or a unique device identification or address.

12. The method of claim 9, wherein the operating state comprises at least one of ON, OFF, STANDBY, or SLEEP.

13. A method of communicating by an applications module, comprising:
receiving an intermittent signal by an applications module interface indicating an operating state and a device parameter;
selecting a communications channel based at least in part on the device parameter;
displaying the operating state by the operations module;
transmitting an operating command signal by the applications module interface; and
transmitting a communications signal by the applications module interface.

14. The method of claim 13, wherein the device parameter comprises at least one of a signal strength, distance, class of device, preference class of device, security settings, service identification, or a unique device identification or address.

15. The method of claim 13, wherein the operating state comprises at least one of ON, OFF, STANDBY, or SLEEP.

16. An article comprising a storage medium having stored thereon instructions that, when executed by a computing platform, results in:
receiving an intermittent signal by an applications module interface indicating an operating state and a device parameter;
selecting a communications channel based at least in part on the device parameter;
displaying the operating state by the operations module;
transmitting an operating command signal by the applications module interface; and
transmitting a communications signal by the applications module interface.

17. The article of claim 16, wherein the device parameter comprises at least one of a signal strength, distance, class of device, preference class of device, security settings, service identification, or a unique device identification or address.

18. The article of claim 16, wherein the operating state comprises at least one of ON, OFF, STANDBY, or SLEEP.

19. A wireless communications system, comprising:
a communications module adapted to receive and transmit a communications signal at a first frequency by a radio frequency element and at a second frequency by a communications module interface;
an applications module adapted to receive and transmit the communications signal at the second frequency by an applications module interface;
a power management element to periodically inactivate an applications processor to reduce power consumption of the applications module;
a voice call element connected to the applications processor for voice communications; and
the communications module interface to transmit and receive the communications signal wherein the communications module interface transmits an operating state signal and receives an operating command signal.

20. The wireless communication system of claim 19, wherein the applications module is physically connected to the communications module

21. The wireless communication system of claim 19, wherein the first frequency is a long-range wireless protocol comprising at least one of a wide area network (WAN), a general packet radio system (GPRS), enhanced data rates for global evolution (EDGE), or third-generation wireless (3G).
